(19) United States
(12) Patent Application Publication
(10) Pub. No.: US 2016/0358257 A1
(43) Pub. Date: Dec. 8, 2016

(54) METHOD AND SYSTEM FOR PROCESSING ELECTRONIC DATA TRANSACTION MESSAGES

(71) Applicant: Nasdaq Technology AB, Stockholm (SE)

(72) Inventors: Johan BERGENUDD, Danderyd (SE); Henrik ROSÉN, Stockholm (SE)

(21) Appl. No.: 15/238,746

(22) Filed: Aug. 17, 2016

Related U.S. Application Data
(62) Division of application No. 14/227,945, filed on Mar. 27, 2014.
(60) Provisional application No. 61/806,049, filed on Mar. 28, 2013.

(51) Int. Cl. G06Q 40/04

(52) U.S. Cl. CPC G06Q 40/04

(57) ABSTRACT

Data transaction request message information associated with a user, a first limit parameter associated with the user, and a second limit parameter associated with the user are stored in memory. A processing system calculates, at a first time, data transaction requests associated with the user and a transactional rate parameter associated with the user based on a relationship between the data transaction requests associated with the user and the second limit amount parameter. Data transaction request messages received from the user between the first time and a second later time are monitored. The transactional rate parameter is adjusted based on data transaction requests associated with the user received between the first and second times. A transactional limit parameter is calculated using the data transaction requests associated with the user, the transactional rate parameter, and the first limit parameter. When the transactional limit parameter is exceeded, execution of further data transactions of a first type requested by the user between the first time and the second later time is suspended.

### PRIORITY APPLICATIONS

This application is a divisional of U.S. patent application Ser. No. 14/227,945, filed Mar. 27, 2014, which claims priority from U.S. provisional patent application Ser. No. 61/806,049, filed on Mar. 28, 2013, the contents of each of which are incorporated herein by reference.

### TECHNICAL OVERVIEW

The technology relates to processing electronic data transaction messages. Non-limiting example embodiments apply the technology to manage delegated risk limit handling for purposes of foreign exchange (FI) trading and clearing.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND

Clearing relates to the activities from the time a commitment is made for a contract transaction until it is settled. That clearing time period (the cycle time for completing the transaction) is much longer than the time it takes for the transaction commitment to occur, e.g., a buy-sell match. Clearing itself involves the management of post-trading and pre-settlement credit exposure to ensure that trades are settled in accordance with market rules, even if a buyer or seller might become insolvent prior to settlement. Clearing processes typically include reporting/monitoring, risk margining, netting of trades to single positions, and/or default handling.

Settlement is a process where securities or interests in securities are delivered, usually against (in simultaneous exchange for) payment of money, to fulfill contractual obligations arising under financial instrument trades. For example, the settlement date for marketable stocks might be 3 business days after the trade is executed, and for listed options and government securities, it might be 1 day after the execution. As part of performance on the delivery obligations entailed by the trade, settlement involves the delivery of securities and the corresponding payment.

Multiple risks arise for the parties during the settlement time, which are managed by the clearing process. Clearing also typically involves modifying the contractual obligations associated with the trade so as to facilitate settlement. A clearing house is a financial entity that provides clearing and settlement services for financial and commodities derivatives and securities transactions. A clearing house intercedes between two clearing entities (also known as clearing members) in order to reduce the risk that one (or more) clearing participants fails to honor its trade settlement obligations. A clearing house reduces the settlement risks by (1) netting (netting means to allow a positive value and a negative value to set-off and partially or entirely cancel each other out) offsetting transactions between multiple counterparties, (2) requiring collateral or margin deposits, (3) providing independent valuation of trades and collateral, (4) monitoring the credit worthiness of clearing participants, and in many cases, (5) providing a guarantee fund that can be used to cover losses that exceed a defaulting clearing participant's collateral on deposit.

Once a trade is executed by two counterparties, the trade is provided to a clearing house which then “steps” in between the two original traders' clearing firms and assumes the legal counterparty risk for the trade. In derivatives trading markets, the clearing house interposes between buyers and sellers as a legal counterparty—i.e., the clearing house becomes the buyer to every seller and the seller to every buyer. The process of transferring the trade title to the clearing house is typically called “novation.” As a result, there is no need for the counterparties to assess the credit worthiness of the opposing party. Rather the credit risk faced by the participants is the risk of a default from by the clearing house. Thus, a clearing house assumes the risk of settlement failures and also isolates the effects of a failure of a market participant.

A multitude of economic forces impact the world's currencies, including interest rate differentials, comparative rates of inflation, central bank intervention and political stability just to mention a few. Moreover, in times of global uncertainty some currencies may benefit from perceived “flight-to-safety” status. Also, if one country's economic outlook is perceived as strong by market forces, its currency may be firmer than another (weaker) country's currency. As a consequence, the foreign exchange market, also known as forex or FI currency trading, is the largest, most liquid financial market in the world and typically involves the simultaneous purchase of one currency, while selling another currency. In a typical foreign exchange transaction, a party purchases some quantity of one currency by paying some quantity of another currency. Hence, currencies are typically traded in pairs, such as U.S. dollars/Euros (USD/EUR) or Japanese yen/U.S dollars (JPY/USD). The average daily turnover in the global foreign exchange and related markets is continuously growing. According to the 2010 Triennial Central Bank Survey, coordinated by the Bank for International Settlements, average daily turnover was US$3.98 trillion in April 2010. Of this $3.98 trillion, $1.5 trillion was spot transactions and $2.5 trillion was traded in outright forwards, swaps, and other derivatives.

FI can be traded in a multitude of ways and markets. One example is Over the Counter (OTC) contracts that are less regulated than traditional exchanges, making them more flexible and an attractive device to certain investors and certain markets. Another way is trading through the FI interbank market, which is a global network of the world's banks with no centralized location for trading, or they can be traded in centralized matching and clearing environments. In fact, the growth of electronic execution and the diverse selection of execution venues have lowered transaction costs, increased market liquidity, and attracted greater participation from many customer types. Regardless of trading venue, the FI market is a 24-hour-per-day market during the FI business week. The trading day starts in Asia, extends over to Europe and then into the U.S. daytime trading hours. Currencies are traded around the world, around the clock, from Monday morning (Sunday afternoon New York time) in New Zealand/Asia to the close of the business week on Friday afternoon in New York.

However, the highly liquid and volatile currency markets tend to offer opportunities for speculators, giving rise to potential counter party risk situations. While the 24-hour-per-day market during the FI business week global trading offers flexibility for traders all around the world, the risk management and clearing mechanisms have not kept pace and need improvement. For example, even though the FI trading venue accept orders 24-hours-per-day during the FI business week, the Clearing House is closed for part of each 24 hour FI trading day. During those closed time periods, the risk associated with uncleared trades increases.

Accordingly, there is a need for systems and methods to allow delegation of risk management and credit margin mechanisms after daily closure of local Clearing Houses in order to provide a mechanism that manages the risk in a more complete and comprehensive way, is robust and easy to use by a trading venue, and makes sure that the Clearing House has sufficient collateral in place for the trading activity, e.g., in 24-hour-per-day markets.

### SUMMARY

Certain example embodiments provide for a computer server and for a method of processing electronic data transaction messages. Data transaction request message information associated with a user, a first limit parameter associated with the user, and a second limit parameter associated with the user are stored in memory. A processing system calculates, at a first time, data transaction requests associated with the user and a transactional rate parameter associated with the user based on a relationship between the data transaction requests associated with the user and the second limit amount parameter. Data transaction request messages received from the user between the first time and a second later time are monitored. The transactional rate parameter is adjusted based on data transaction requests associated with the user received between the first and second times. A transactional limit parameter is calculated using the data transaction requests associated with the user, the transactional rate parameter, and the first limit parameter. When the transactional limit parameter is exceeded, execution of further data transactions of a first type requested by the user between the first time and the second later time is suspended.

However, in certain example embodiments, when the transactional limit is exceeded, to permit further data transactions of a second different type requested by the user between the first time and a second later time. Moreover, further data transactions requested by the user between the first time and a second later time may be permitted when the transactional limit parameter is not exceeded based on the monitored data transaction request messages.

Different ones of the data transaction request messages include different units of measure. In certain example embodiments, the different data transaction requests are converted to a same unit of measure. A difference parameter may be calculated for each set of data transaction requests having a different unit of measure, and the current transactional limit may be calculated at a time between the first and second times using the calculated difference parameters.

In example embodiments, the first limit parameter and the second limit parameter may be adjusted using a predetermined factor.

Example embodiments include a computer system for processing electronic data transaction messages that includes a backend computer server configured to determine a first limit parameter with a user and a second limit parameter associated with the user and a frontend computer server configured for communication with the backend server and to receive from user devices electronic data transaction request messages associated with the user and from the backend computer server the first limit parameter associated with a user and the second limit parameter associated with the user. The frontend server includes a memory that stores electronic data transaction request message information associated with a user, the first limit parameter associated with the user, and the second limit parameter associated with the user. The frontend server also includes a processing system that includes at least one processor. The processing system, at a first time, calculates data transaction requests associated with the user and a transactional rate parameter associated with the user based on a relationship between the data transaction requests associated with the user and the second limit amount parameter. It monitors data transaction request messages received from one or more client computers associated with the user between the first time and a second later time and adjusts the transactional rate parameter based on currently pending data transaction requests associated with the user received between the first and second times. The processing system calculates a transactional limit parameter using the data transaction requests associated with the user, the transactional rate parameter, and the first limit parameter. It also determines whether the transactional limit parameter is exceeded, and when the transactional limit parameter is exceeded, the processing system suspends execution of further data transactions of a first type requested by the user between the first time and the second later time.

The features described herein may be combined to form additional embodiments and sub-elements of certain embodiments may form yet further embodiments.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 illustrates a non-limiting example function block diagram of a computer-implemented server system coupled via a network to a client system configured to create and send data transaction requests to the server;

FIG. 2 illustrates a non-limiting example function block diagram of a computer-implemented server in the system of FIG. 1;

FIG. 3 is a flow chart showing an example process for processing data transaction requests received from client computers according to certain example embodiments;

FIG. 4 illustrates a non-limiting example function block diagram of a computer-implemented exchange system coupled via a network to a client system configured to create and place FI trade orders with the exchange;

FIG. 5 illustrates an exposure graph based on a treasury model;

FIG. 6 illustrates an exposure graph based on an example risk management model that takes into account additional factors not considered in the treasury model;

FIG. 7 illustrates a non-limiting example function block diagram of a computer-implemented FI exchange platform coupled via a network to a computer-implemented FI clearing house platform;

FIG. 8 is a flow chart showing an example process for processing FI trade orders received from client computers according to certain example embodiments; and

FIG. 9 is a graph showing a non-limiting example of an official margin run and collateral check by the clearing house platform that resulted in example excess collateral, RiskMarginOpen, and an average margin parameter for all currency pairs.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on non-transitory computer-readable storage medium and when the instructions are executed by a computer or other suitable processor control, the computer or processor performs the functions.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred. A description of a process is a description of an apparatus for performing the process. The apparatus that performs the process may include, e.g., a processor and those input devices and output devices that are appropriate to perform the process.

Various forms of non-transitory, computer-readable media may be involved in carrying data (e.g., sequences of instructions) to a processor. For example, data may be (i) delivered from RAM to a processor; (ii) carried over any type of transmission medium (e.g., wire, wireless, optical, etc.); (iii) formatted and/or transmitted according to numerous formats, standards or protocols, such as Ethernet (or IEEE 802.3), SAP, ATP, Bluetooth, and TCP/IP, TDMA, CDMA, 3G, etc.; and/or (iv) encrypted to ensure privacy or prevent fraud in any of a variety of ways well known in the art.

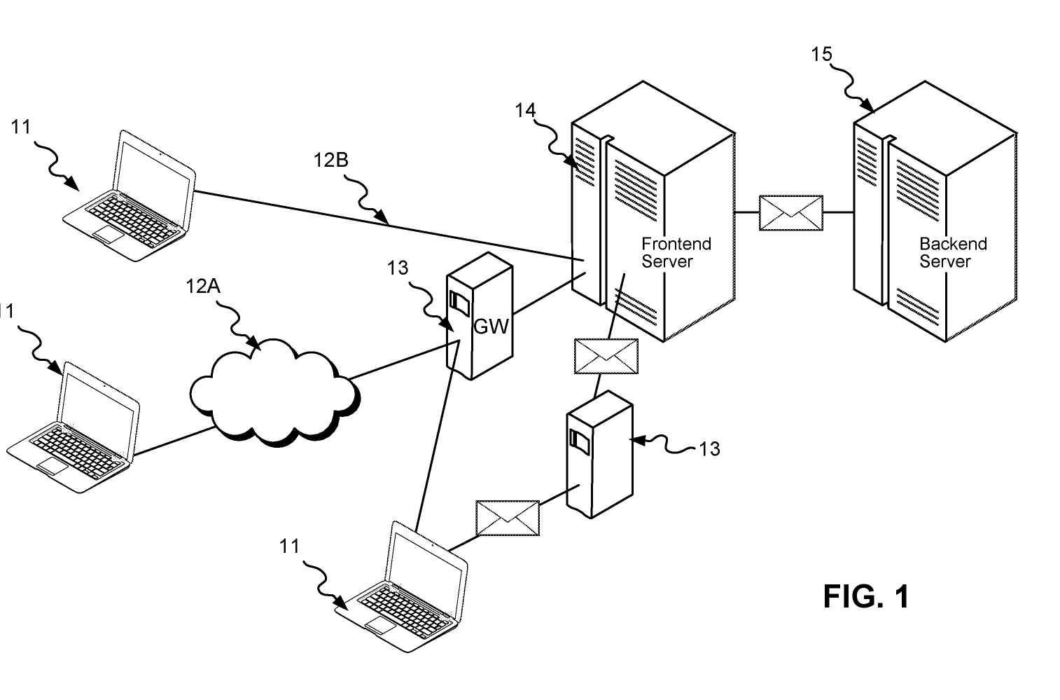

FIG. 1 illustrates a non-limiting example function block diagram of a computer-implemented server system coupled via a network to a client system configured to create and send data transaction requests to the server. Client systems 11 can be implemented using a personal computer, PDA device, cell phone, server computer, or any other system/device configured to electronically communicate with a frontend server platform 14. A gateway system 13 may be used to facilitate communication between client devices 11 and the server 14. The client systems 11 can be associated with an individual and/or an entity that is making data transaction requests to the server 14. A backend server platform 15 communicates over a network with the frontend server platform 14 and is available during certain time periods to perform various backend services for the frontend server platform 14. The servers 14 and 15, gateways 13, and client devices 11 communicate using electronic data messages. Typically, the frontend server 14 receives and processes data transaction requests from client devices 11, and performs such requests when appropriate conditions are satisfied. The backend server 15 performs further processing on completed data transactions independently of the processing performed at the frontend server 14.

Each client system 11 includes a central processing unit (CPU), a memory, and a data transmission device. The data transmission device can be, for example, a network interface device which connects the client system to the network. The connection can be wired, optical, or wireless and can connect over a Wi-Fi network, the Internet (12A), or a cellular data service, for example. In certain examples, client systems 11 may have a dedicated connection 12B to the server platform 14. The data transmission device can also be an input/output device that allows a client system to place the data on a computer-readable storage medium. The data transmission device is capable of sending and receiving data (e.g., a transceiver).

The frontend server system 14, gateway system 13, and backend server system 15 may include one or more CPUs, memories, and data transmission devices. In example embodiments, these systems may include multiple processors and/or memories and may be designed for fail-safe redundancy. The data transmission device can be, for example, a network interface device capable of sending and receiving data (e.g., a transceiver). The memories store data transaction requests, completed data transactions, and computer programs for controlling processing of the data transactions and requests. It will be appreciated that these systems may be may physically separate computing systems or may be included in a single computer system.

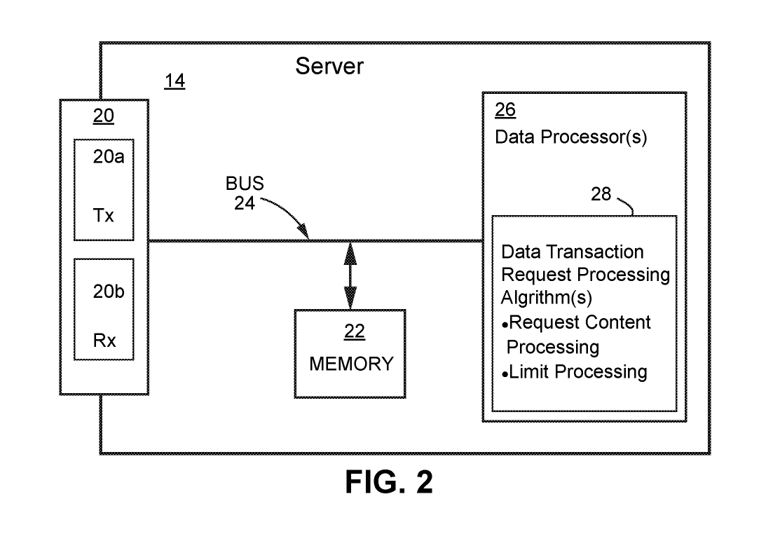

FIG. 2 illustrates a non-limiting example function block diagram of the computer-implemented server 14 in the system of FIG. 1. The server 14 includes one or more data processors 26 coupled via a communications bus 24 to a communications interface 20. The interface includes, for example, a transmitter 20a and a receiver 20b for transmitting and receiving electronic data messages. One or more memories 22 are coupled to the bus 24 and may include RAM and other types of memory such as magnetic, flash based, solid state, or other storage technology such as network attached storage (NAS) to hold large amounts of data. Data may be stored in the memories 22 in any suitable fashion including for example relational, object orientated, or other types of databases. The data processor(s) 26 implement/execute data transaction processing algorithms that may be stored in the memory 22 and/or in internal memory to the processor(s) 26. One or more algorithms cause the data processor(s) 26 to perform processing based on the content of the data transaction requests from the client devices 11. In addition, one or more algorithms cause the data processor(s) 26 to perform limit processing to determine whether data transaction requests from the client devices 11 exceed one or more predetermined data transaction limits.

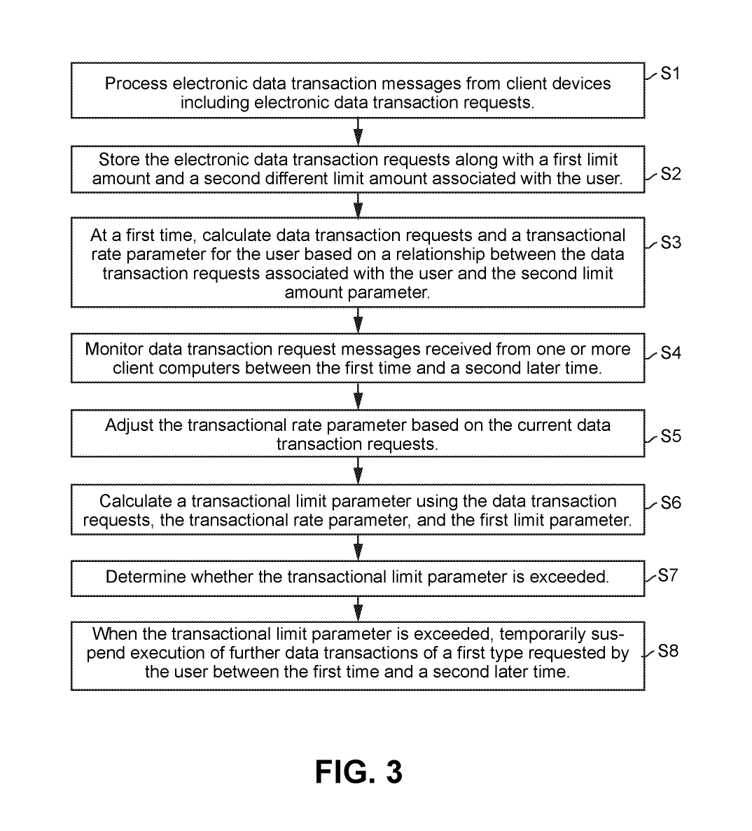

FIG. 3 is a flow chart showing an example process for processing data transaction requests received from client computers according to certain example embodiments. The frontend computer server 14 processes electronic data transaction messages from client devices 11 including electronic data transaction requests (step S1). The memory 22 stores those electronic data transaction requests along with a first limit parameter and a second different limit parameter associated with the user (step S2). The processor(s) 26, at a first time, calculate data transaction requests and a transactional rate parameter for the user based on a relationship between the data transaction requests associated with the user and the second limit amount parameter (step S3). Data transaction request messages received from one or more client computers between the first time and a second later time are monitored (step S4), and the transactional rate parameter is adjusted based on the current data transaction requests (step S5). The processor(s) calculate a transactional limit parameter using the data transaction requests, the transactional rate parameter, and the first limit parameter (step S6) and determine whether the transactional limit parameter is exceeded (step S7). When the transactional limit parameter is exceeded, execution of further data transactions of a first type requested by the user is suspended between the first time and a second later time (step S8).

The technology described above has multiple data transaction processing applications. The following further example embodiments, which are not exclusive or limiting, relate to delegated risk management system and method applications for clearing foreign exchange (FI) contracts. In these example applications of the technology, the example financial instruments are currencies, but the technology may be applied to any tradable item—e.g., securities, derivatives, commodities, stocks, bonds, cash, swaps, futures, foreign exchange, options, gas electricity, and other items.

In this currency trading context, clearing (described in the background) is a process through which a Clearing House becomes a buyer to each seller of a FI contract, and a seller to each buyer of a FI contract, and in which the Clearing House assumes responsibility for protecting buyers and sellers from financial loss by assuring performance on each contract, i.e., reconciling orders between transacting parties. By assuming an intermediary role as a Clearing House, and employing credit screening and risk management mechanisms, the Clearing House provides a safer and more controlled fashion for trading. Typically, trading and clearing occur at different venues with trading taking place at an electronic trading exchange and clearing taking place at a computer-implemented Clearing House, with the two typically being functionally and sometimes even geographically separated.

In one example embodiment, a company (Company A) set up a market place for trading FI products at Exchange A and the trades created at Exchange A will be cleared through a clearing house operated by another legal entity (Company B) that is external to Exchange A. In other words, the clearing of trades from Exchange A will be executed through Clearing House B. The FI trading at Exchange A in the example operates 24/7 (all day), 5 days per week. But for part of that time, the Clearing House B is closed, even though Exchange A accepts trades during those hours when Clearing House B is closed. In order to protect Clearing House B from adverse risk and to guarantee that all trades at Exchange A will be cleared, example embodiments introduce one or more “position” limits, against which position limit Exchange A will risk validate all trades. A position is a binding commitment (a contract) to buy or sell a given amount of a financial instrument, e.g., a currency pair. A position is open until is closed by entering into a trade that takes the opposite position. A user that exceeds a position limit set for that user may be suspended at least temporarily from further trading, i.e., the exchange will not post trading requests for further open currency pair positions at least temporarily.

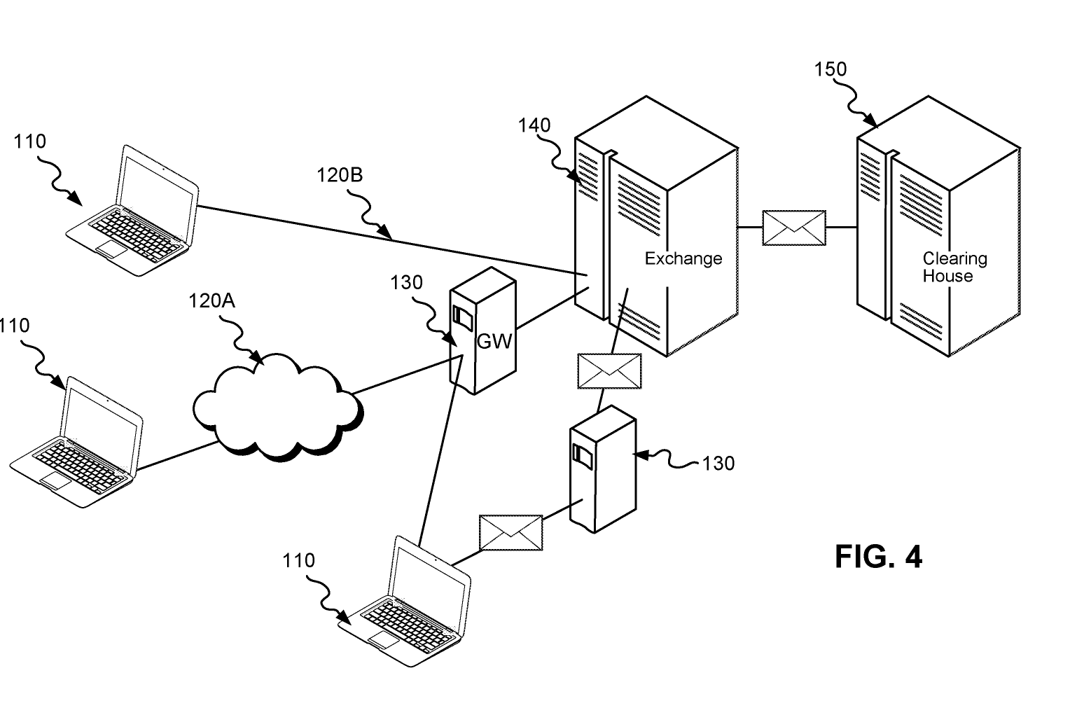

FIG. 4 illustrates a non-limiting example function block diagram of a computer-implemented exchange and clearing system 100 coupled via a network to a client system configured to create and place FI trade orders with the exchange. The exchange system comprises trader terminals 110 in the form of client devices that are used for, e.g., issuing order data messages, i.e., input trade request messages received by an automated exchange platform 140. The client devices 110 are connectable, for example over the internet 120A, or over some other communications connection like a dedicated fibre (such as a T1-line or similar) 120B or other suitable communications connection, to an electronic marketplace, i.e., the automated exchange platform 140. The exchange platform 140 is further connected to a Clearing House 150, e.g., via a similar type of connection. The connections may be direct or indirect through one or more intermediate components. Such intermediate components may include both hardware and software based components. The computer-implemented trading exchange 140 includes or communicates with an associated computer-implemented clearing house 150 that includes one or more computers for maintaining account records, clearing executed trades, reporting the same, and performing other clearing functions including ensuring that margin limits are monitored and adhered to by trading entities. Such trading entities typically have an account with the clearing house that includes open positions associated with the account, a margin requirement for the account, a current available margin, and other clearing related parameters.

The automated exchange platform 140 and/the Clearing House platform 150 can be hosted on a single computer server, or on a cluster of computer servers. Typically, the automated exchange platform 140 comprises a matching engine (ME). Sometimes the client devices 110 are connected to the automated exchange platform 140 through a gateway 130. The gateway 130 is connected to, or is a part of, the automated exchange platform 140 and configured to receive market actions, i.e., orders and/or quotes from client devices 110. A gateway 130 may be connected to the automated exchange platform 140 via a dedicated network and forwards market actions (e.g., trade requests to buy or sell a currency pair) to the automated exchange platform 140 and further usually broadcasts market information (e.g., trade updates) back to the client devices 110. Information being communicated to and from the automated exchange platform 140 and the client devices 110 may be communicated via a single communication path or multiple paths. While the client devices 110 are illustrated as client devices that traditionally are associated with manual input of market actions by human operators, the client devices 110 can also be implemented as algorithmic trading units, sometimes termed automatic order generators, having manual input means for control of said algorithmic trading unit. The algorithmic trading units may be programmed with instructions to automatically generate sell and/or buy orders and quotes (or changes/cancellations thereof) in response to market data broadcasted from the automated exchange platform 140. The client devices 110 also represent market makers inputting quotes to the automated exchange platform 140.

The Clearing House 150 includes margin algorithms implemented using one or more computers that calculate the risk for a range of possible changes in the FI contracts to be cleared resulting from changes in volatility in the currencies portfolios of various clients. Various risk scenarios are typically simulated to determine how much margin needs to be collected from any clearing member as collateral against potential loss resulting from unfavourable price moves. Typically, Clearing House B 160 performs regular margin “runs” for each user/member portfolio account throughout the day and at the time when the Clearing House B closes each day, e.g., 20:00 hours local time. These margin runs identify the overall risk in each clearing member's FI portfolio account. After an official margin run, each account's margin and collateral are compared, and the result of the comparison is used to update the limit or headroom within which the account user/entity is permitted to trade against.

The official margin requirement determined by the clearing house is typically based on currency prices and portfolio positions at the time of the margin calculation. But, because the FI market continues trading activity after the clearing house closes for the business day, portfolio positions and currency prices may very well change after the official margin run. Another problem arises from the fact that there is not a 1-to-1 relationship between the margin calculation and the limit exposure. In fact, two portfolios can have the same exposure, but have very different risk, sometimes referred to as Risk Margin Open (RMO) for FI markets.

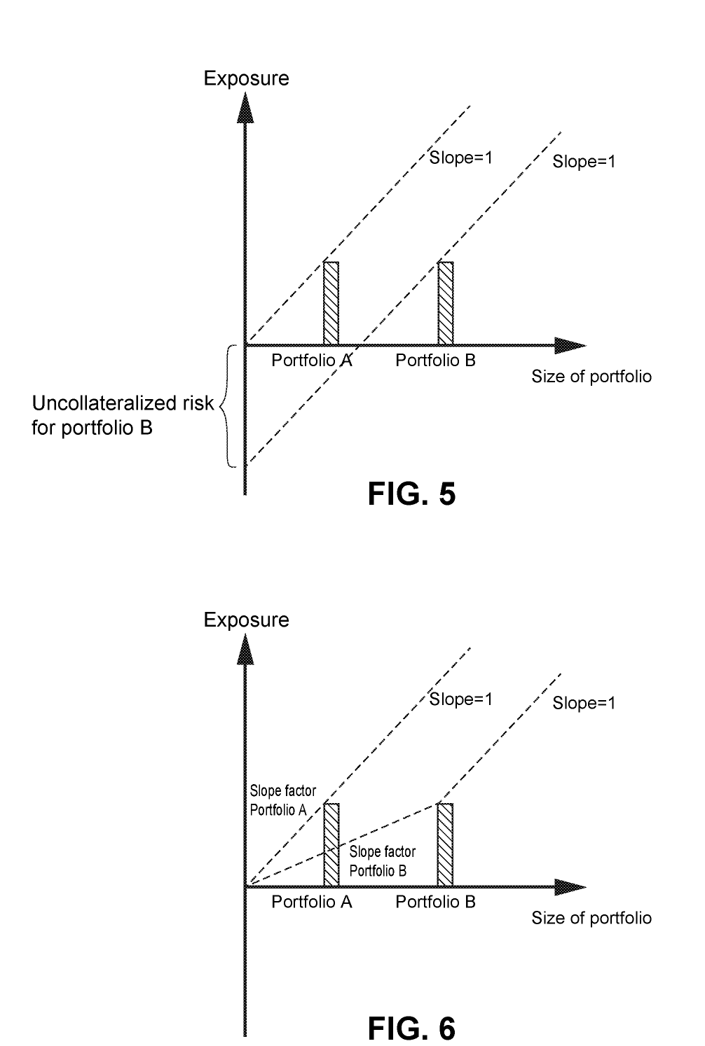

FIG. 5 illustrates an exposure graph based on a treasury model. In the example in FIG. 5, portfolio B is a large, hedged portfolio with a relatively low Risk Margin Open (RMO). Portfolio A is, on the other hand, a smaller but a more risky portfolio. Even though these two portfolios have different risk profiles, they have the same financial exposure based on their respective portfolio positions and the currency prices at that point in time assumed in the graph. If the two portfolios have the same amount of collateral in place, then the lower risk portfolio B may have larger headroom (because of its lower accessed risk) and can place a larger trade volume than portfolio A which has smaller headroom (because of its higher assessed risk). In other words, because portfolio B is a lower risk, it should be able to take on more risk than portfolio A given the same amount of collateral.

Consider a situation where portfolio B closes down all of its open positions, thereby creating more headroom, and then opens up the very same positions as portfolio A. Based on a treasury model shown in FIG. 5, portfolio B shows a substantial uncollateralized “negative” risk, which unfairly restricts trading possibilities for portfolio B during evening trading while the clearing house is closed. The treasury model is a model for calculating foreign exchange exposure and risks taking into consideration various factors including random fluctuations of exchange rates.

A clearinghouse is typically closed during the night, and therefore, is unable to perform risk calculations, make adaptations to required collateral, and to set risk limits for users. However, the exchange may accept order messages and have trades take place, even during clearing house off hours. The clearinghouse needs to be protected in this situation from adverse risk, e.g., a scenario where a user trades above the user's set risk limit, which is typically based on posted collateral requirements and the traded portfolio composition. In one aspect of example embodiments, the exchange validates trades and suspends a user who breaks a risk limit set for that user. Another aspect relates to a scenario where a user sells portions of the user's portfolio during the night operation, and where using traditional clearing approaches constrains the user with a risk limit lower than it needs to be. This is because such traditional clearing approaches set the risk limit based on the user's portfolio composition, which may change during the off hours, and the user's posted collateral, which does not change during those off hours. Hence, there is a high likelihood that the user ends up not being able to trade as much as the user's posted collateral normally would allow. This is sometimes referred to as uncollateralized “negative” risk, i.e., a “positive” credit risk associated with the user in view of the user's posted collateral and portfolio composition. Example embodiments avoid problems associated with uncollateralized “negative” risk.

In contrast to FIG. 5, FIG. 6 illustrates an exposure graph based on a more accurate and reliable risk management model that takes into account additional factors not considered in the treasury model. This new model considers the risk in a portfolio and links the maximum headroom that can be created, e.g., by a portfolio closing down open positions, to a current excess collateral and a Risk Margin Open (RMO) parameter associated with that portfolio. The relationship between the exposure and the RMO is taken into account, and “both sides” of currency pairs, i.e., “short” and “long” balances, are preferably converted to a common or “notional” currency such as USD. The effect of such a model is evident in FIG. 6 which shows that increasing the exposure for a portfolio may only be done at a certain rate or slope, the example slope being 1 in the Figure. But unlike FIG. 5, decreasing the exposure for that portfolio may be done at a different rate or slope, e.g., less than 1, so that as portfolio B reduces its exposure by closing down positions. In the latter situation, the margin allocated for portfolio B may be increased by the trading exchange while still protecting the clearing house from undesired risk and exposure.

Example embodiments more accurately and reliably address uncollateralized risk during off-clearing time periods, while at the same time avoiding unnecessary trading constraints during those time periods, by determining the margin requirement for a portfolio using a position limit parameter that reflects the actual current portfolio risk. More margin headroom is provided should trades that reduce risk in the portfolio be executed, and the margin headroom for that portfolio is reduced when trades that increase risk in the portfolio are executed. For each new trade, a delta parameter is calculated, per currency, and the delta's effect on the remaining margin limit for the portfolio depends on whether the risk in that specific currency reduces or increases. The maximum amount a portfolio may trade depends on the excess collateral or headroom and the risk associated with that specific portfolio. The position limit parameter is applied to each portfolio's margin requirement.

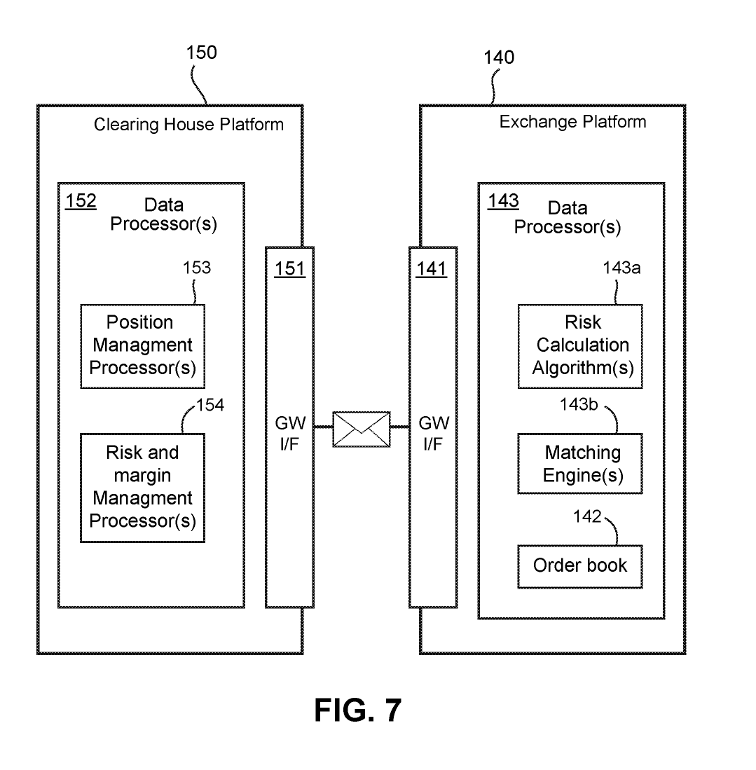

FIG. 7 illustrates a non-limiting example function block diagram of a computer-implemented FI exchange platform 140 coupled via a network to a computer-implemented FI clearing house platform 150. The Exchange 140 includes a gateway interface unit 141 configured to receive order data messages for matching in a matching engine 143b implemented using data processor(s) 143 of the Exchange 140. An order data message is received by a receiver 141b in the gateway 141 and communicates the received order data message to the data processor(s) 143. The matching engine 143b compares order information in the order data message to orders previously stored in an electronic order book 142 to find a match. Should the received order data message not be matched, that order is then stored in the electronic order book 142. Should a match be identified, a deal or trade is created based on the received order data message and a corresponding matching order in the order book 142. The executed trade or deal is sent from the exchange platform 140 to the clearing house platform 150 in the form of a trade or deal data message. The exchange platform 140 and the clearing platform 150 may include any suitable types of transceivers in the gateway interfaces 141 and 151. The clearing house platform includes data processor(s) 152 that include position management processor(s) 153 and risk and margin management processor(s) 154.

Typically, on regular and predefined occasions, the clearing house platform 150 sends either a data file, or a single or series of data message(s) produced by the position management processor(s) 153 and/or risk and margin management processor(s) 154 to the exchange platform 140. The transmitted data may include account information for each clearing member such as, but not limited to, portfolio positions, position limits, and margins. In one example, such data is transmitted via a transceiver of the clearing house gateway 151 to a transceiver of the exchange gateway 141 at 20:00 hours CET. The transmitted data is received by the exchange platform 140 and stored in a non-volatile memory storage such as memory 22 shown in FIG. 2. Again, such memory typically may include, but is not limited to, a RAM, a ROM and/or another type of memory to store data and instructions that may be used by processing logic. The received data from the clearing house platform 150 is used for margin, risk, and/or exposure related calculations (examples are described below) based on risk calculation algorithms 143a executed by the data processor(s) 143.

As should be appreciated, processing systems may include additional and/or different components than what is illustrated. Moreover, the processing logic may include a processor, microprocessor, an ASIC, FPGA, or the like. In addition, processing logic circuitry may generate control messages and/or data messages and cause those control messages and/or data messages to be transmitted via transceivers and/or interfaces. Processing logic circuitry may also process control messages and/or data messages received from transceivers and/or interfaces.

Either platform 140/150 may perform certain operations by executing on one or more processors software instructions contained in a non-transitory computer-readable medium including one or more physical and/or logical memory devices. The software instructions may be read into memory from another computer-readable medium or from another device via interfaces. The software instructions contained in memories may cause processing logic to perform processes described herein. Alternatively, hardwired circuitry may be used in place of or in combination with software instructions to implement processes described herein. Thus, embodiments described herein are not limited to any specific combination of hardware circuitry and software.

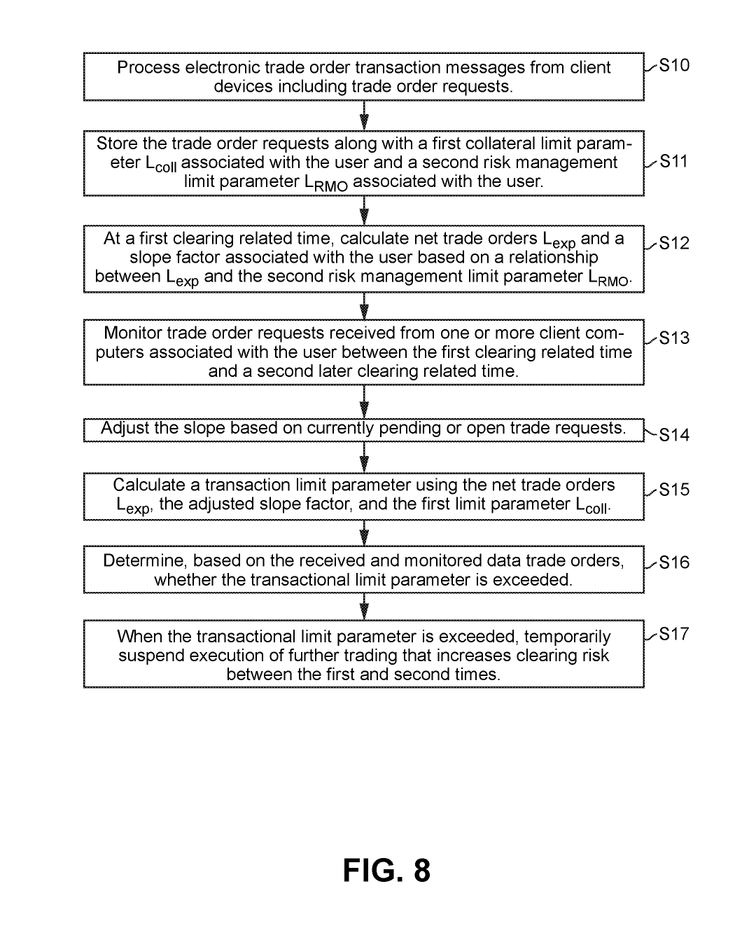

FIG. 8 is a flow chart showing an example process for processing FI trade orders by an exchange platform that are received from client computers according to certain example embodiments. Process electronic trade order transaction messages from client devices including trade order requests (step S10). The trade order requests are stored along with a first collateral limit amount associated with the user and a second risk management limit amount associated with the user (step S11). At a first clearing related time, net trade orders Lₑₓₚ and a slope factor associated with the user are calculated based on a relationship between Lₑₓₚ and the second risk management limit parameter L_{RMO} (step S12). Trade order requests received from one or more client computers associated with the user are monitored between the first clearing related time and a second later clearing related time (step S13). The slope is adjusted based on currently pending or open trade requests (step 14). A trade limit is calculated using the net trade orders Lₑₓₚ, the adjusted slope factor, and the first limit parameter L_{coll} (step S15). The exchange determines, based on the received and monitored data trade orders, whether the transactional limit parameter is exceeded (step S16). When the transactional limit parameter is exceeded, execution of further trading that increases clearing risk between the first and second times is suspended (step S17).

Example embodiments for enhanced Exchange/Clearing cooperation are described in more detail below in which each user portfolio of open currency trade positions is also referred to as an account. In general, a position limit parameter is set for each user account and used by the exchange to “cover” a risk for intra-day position changes for that account, e.g., trading that occurs when the clearing house is closed during the night, that would otherwise have been uncovered with traditional clearing approaches. The position limit parameter, in this example, is expressed as a notional amount in USD (i.e., in a common currency). When the clearing house platform completes margin determinations for user portfolio accounts (a margin “run”), the clearing house platform provides to the exchange platform (1) an excess collateral amount for each user portfolio that is used to set an updated collateral limit parameter, L_{collateral}, and (2) a RiskMarginOpen (RMO) value that is used to set an updated RMO limit parameter, L_{RMO}.

These limit parameters and the positions on each account, together with a last trading number included in the margin calculation, are sent from the clearing house platform to the exchange platform. The last trading number decides which open trade positions that the exchange will include in determining an exposure limit parameter, Lₑₓₚ. A position limit parameter is based on a current exposure, the exposure limit parameter, Lₑₓₚ, and the excess collateral L_{collateral} parameters. The current exposure takes into account a slope factor like that shown in FIG. 6. The end result is that margin requirements provided by the clearing house for an account may be adjusted higher or lower if the account risk decreases or increases after closure of the clearing house, e.g., 20:00 hours local time. A higher margin means that a higher trading amount is available, and a lower margin means that a lower trading amount is available. The limit values Lₑₓₚ and L_{RMO} are further used to calculate a rate or slope factor that is introduced to make sure that each account is not uncollateralized when the clearing house is closed, e.g., during the night.

The clearing house platform uses excess collateral and RMO per account to calculate L_{collateral} and L_{RMO} expressed as notional values in USD. In addition, the Clearing House Risk Management processor(s) 154 provide the exchange platform with an average margin parameter (X %) per currency pair regardless of currency. For each new open trade position requested for an account, there will be a reduction of the L_{collateral} and L_{RMO} limits with X % of notional value expressed in USD to reflect “aggregated long” and “aggregated short” separately per currency. This will yield:

$${L}_{collateral} = \frac{Excess collateral in USD}{x \%} \& {L}_{RMO} = \frac{RMO in USD}{x \%}$$

The X margin factor is a parameter the Clearing House calculates during normal Clearing House business hours based on portfolio composition, collateral, and market volatility. Typically, it is a normalization factor for setting a risk limit. If a user buys, the user reduces the user's associated collateral head room, and if the user sells, the user increases the user's associated collateral headroom. In essence, if the user sells riskier positions, the user is “rewarded” with additional collateral headroom. However, X margin factor calculations are not made by the Clearing house during off hours.

Although “long” and “short” are assessed separately, the average margin parameter X % is based on currency pairs, which means that both L_{collateral} and L_{RMO} need to be multiplied with a factor. In an example embodiment, this factor is the integer two (2). The resulting limit parameters are referred to as L_{collateral2} and L_{RMO2} . In one example, the clearing house determines L_{collateral}, L_{RMO}, and X % and sends them to the exchange platform after each official margin run, and the exchange determines L_{collateral2} and L_{RMO2}.

The position limit for each account is be calculated, monitored, and adjusted by the exchange platform. New trades occurring during off-clearing house hours will cause an update of the position limit for each account and thus the available amount to trade for each account. The position limit calculation is based in example embodiments on a gross-net approach, i.e., gross per currency but net in the same currency. The procedure followed includes three general steps:
1. Determine if the currency portfolio is “net long” or “net short” in respective currency represented using an exposure limit parameter Lₑₓₚ.
2. Convert the absolute numbers to USD.
3. Add up all absolute numbers to a total amount.
   The exposure associated with each account at closure of the clearing house is the starting point, and the exchange platform determines if the portfolio is “net long” or “net short” in respective currency and stores these exposure limit parameter Lₑₓₚ numbers for each account. The exchange platform also converts the absolute numbers to USD and adds them together in the process of calculating Lₑₓₚ.

In order to make sure that each account is not uncollateralized during the night, a slope factor is introduced:

$$Slope factor = min ( \frac{{L}_{{RMO}_{2}}}{{L}_{exp}} ; 1 )$$

If Lₑₓₚ=0, then there are no open positions for the account, and consequently, there is no need for a slope factor at that point.

For each new trade, the exposure is preferably updated, and a delta, in each currency, is calculated. The delta is the difference between an absolute start exposure value and an absolute current exposure value for each currency, where i is the number of currencies.

deltaᵢ =Abs current notionalᵢ−Abs start notionalᵢ

Should the sum of the deltas be negative, i.e., the risk in a currency is reduced as compared to the starting point, the amount to reduce the current exposure for the account includes the delta parameters multiplied by the slope factor. On the other hand, if the sum of the deltas not be negative, i.e., the risk in a currency is the same or increased as compared to the starting point, the current exposure is determined using the delta value without modification based on slope factor. An equation for a current exposure is as follows:

$$Current Exposure = {\sum }_{i = 1}^{n} Abs start {notional}_{i} - if ( {delta}_{i} < 0 ; {delta}_{i} * slope factor ; {delta}_{i} )$$

where n is the number of currencies and Abs start notationalᵢ is the absolute exposure in currency i. The remaining margin limit is determined as follows:

Remaining limit=Lₑₓₚ−Current Exposure+L_{collateral 2}

A margin limit breach may be defined for example as:

Remaining limit<0

Should an account breach its corresponding remaining margin limit, the exchange platform suspends, at least temporarily, trading for that account and removes orders from the order book for that account suspended member until the suspension is removed. For example, the clearing house can lift the suspension after an intra-day margin call is met for the account. However, the exchange platform preferably permits the account to submit risk-reducing orders that reduce the risk in the account portfolio.

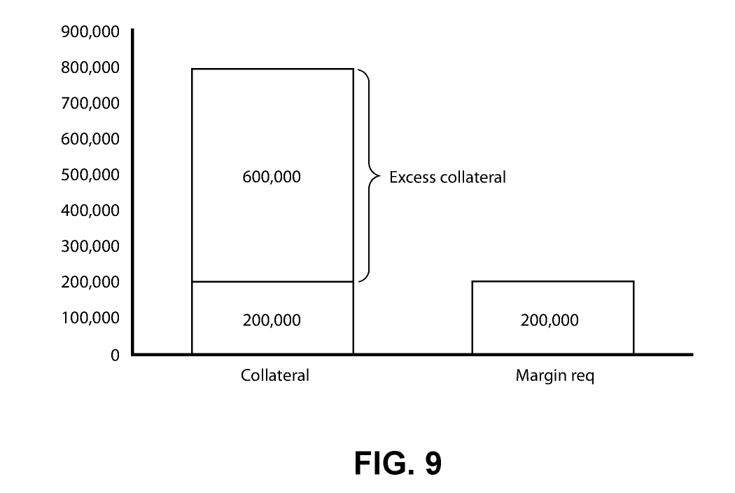

Consider the following detailed, non-limiting example. Assume that the official margin run and collateral check by the clearing house platform resulted in the following: excess collateral of $600,000, and RiskMarginOpen of $200,000, and an average margin parameter for all currency pairs of 4%. This is shown in the example graph in FIG. 9.

Using the equations for L_{collateral} and L_{RMO} above yields;

$${L}_{collateral} = \frac{6000 \; 000}{4 \%} = 15 \; 000 \; 000 \& {L}_{RMO} = \frac{200 \; 000}{4 \%} = 5 \; 000 \; 000$$

$${L}_{{collateral}_{2}} = {L}_{collateral} * 2 = 30 \; 000 \; 000 \& {LL}_{{RMO}_{2}} = {L}_{RMO} * 2 = 10 \; 000 \; 000$$

As a result, the maximum amount this portfolio should be allowed to trade for is $40,000,000. Assume that the portfolio, after the margin run, is as follows:

| | Currency | | | | Amount | Amount |
|---|---|---|---|---|---|---|
| Position | pair | mtm | Long | Short | long | short |
| 1 | EURUSD | 1.33 | EUR | USD | 10,000,000 | −13,300,000 |
| 2 | USD | 1.0 | | | 2,700,000 | 2,700,00 |
| 3 | GBPUSD | 1.6 | USD | GBP | 16,000,000 | −10,000,000 |

The portfolio is:
Net long EUR 10 000 000→10 000 000*1,33=USD 13 300 000
Net long USD 2 700 000→2 700 000*1=USD 2 700 000
Net short GBP 10 000 000→10 000 000*1,6=USD 16 000 000
Lₑₓₚ is determined as follows:

Lₑₓₚ=13 300 000+2 700 000+16 000 000=32 000 000$

The slope factor defines a relationship between Lᵣₘₒ₂ and Lₑₓₚ as expressed above:

$$Slope factor = ( \frac{10 \; 000 \; 000}{32 \; 000 \; 000} ) = 0 , 3125$$

The current exposure and Lₑₓₚ are the same right after the official margin run, i.e., delta=0 for all currencies.

$$Current Exposure = {\sum }_{i = 1}^{n} 13 \; 300 \; 000 - 0 + 2 \; 700 \; 000 - 0 + 16 \; 000 \; 000 - 0 = 32 \; 000 \; 000$$

As a result, the remaining limit at this point is:

Remaining limit=32 000 000−32 000 000+30 000 000=30 000 000$

Assume a trade in GBPUSD takes place after the clearing house closes:

| | Currency | | | | Amount | |
|---|---|---|---|---|---|---|
| Trade | pair | mtm | Long | Short | long | Amount short |
| 1 | GBPUSD | 1.6 | GBP | USD | 1,687,500 | −2,700,000 |

A delta is determined (all figures expressed in USD) as shown in the table below:

| | EUR | USD | GBP |
|---|---|---|---|
| Start notional | 13,300,000 | 2,700,000 | −16,000,000 |
| Abs start notional | 13,300,000 | 2,700,000 | 16,000,000 |
| Trade 1 | 0 | −2,700,000 | 2,700,000 |
| Current notional | 13,300,000 | 0 | −13,300,000 |
| Abs current notional | 13,300,000 | 0 | 13,300,000 |
| Delta | 0 | −2,700,000 | −2,700,000 |

The current exposure is then determined as:

Current exposure=13 300 000−0+2700 000−2 700 000*0,3125+16 000 000−2 700 000*0,3125=30 312 500

The remaining limit to be used is:

Remaining limit=32 000 000−30 312 500+30 000 000=31 687 500

Assume a further after hours trade takes place in GBPUSD.

| | Currency | | | | Amount | |
|---|---|---|---|---|---|---|
| Trade | pair | mtm | Long | Short | long | Amount short |
| 2 | EURGBP | 0.83125 | GBP | EUR | 8,312,500 | −10,000,000 |

A new delta is determined with all numbers still expressed in USD.

| | EUR | USD | GBP |
|---|---|---|---|
| Start notional | 13 300 000 | 2 700 000 | −16 000 000 |
| Abs start notional | 13 300 000 | 2 700 000 | 16 000 000 |
| Trade 1 | 0 | −2 700 000 | 2 700 000 |
| (GBPUSD) | | | |
| Current notional | 13 300 000 | 0 | −13 300 000 |
| Abs current | 13 300 000 | 0 | 13 300 000 |
| notional | | | |
| Delta | 0 | −2 700 000 | −2 700 000 |
| Trade 2 | −13 300 000 | 0 | 13 300 000 |
| (EURGBP) | | | |
| Current notional | 0 | 0 | 0 |
| Abs current | 0 | 0 | 0 |
| notional | | | |
| Delta | −13 300 000 | −2 700 000 | −16 000 000 |

A new value for exposure is calculated:

Current exposure=13 300 000−13 300 000*0,3125+2 700 000−2 700 000*0,3125+16 000 000−16 000 000*0,3125=22 000 000

This current exposure results in a new remaining limit to trade for:

Remaining limit=32 000 000−22 000 000+30 000 000=40 000 000

In other words, all positions have been closed for this account, and the remaining limit is $40 000 000, corresponding to the amount that may be used for trading in this account (L_{collateral2}+Lᵣₘₒ2=40MUSD).

Although various embodiments have been shown and described in detail, the claims are not limited to any particular embodiment or example. None of the above description should be read as implying that any particular element, step, range, or function is essential. All structural and functional equivalents to the elements of the above-described preferred embodiment that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, component, or step in this specification is intended to be dedicated to the public.

1. A computer system for processing electronic data transaction messages, comprising:
a backend computer server configured to determine a first limit parameter associated with a user and a second limit parameter associated with the user;
a frontend computer server configured for communication with the backend server and to receive from user devices electronic data transaction request messages and from the backend computer server the first limit parameter associated with the user and the second limit parameter associated with the user, the frontend server including:
a memory configured to store electronic data transaction request message information associated with the user, the first limit parameter associated with the user, and the second limit parameter associated with the user, and
a processing system that includes at least one processor, the processing system configured to:
at a first time, calculate data transaction requests associated with the user and a transactional rate parameter associated with the user based on a relationship between the data transaction requests associated with the user and the second limit amount parameter;
monitor data transaction request messages received from one or more client computers associated with the user between the first time and a second later time;
adjust the transactional rate parameter based on currently pending data transaction requests associated with the user received between the first and second times;
calculate a transactional limit parameter using the data transaction requests associated with the user, the transactional rate parameter, and the first limit parameter;
determine whether the transactional limit parameter is exceeded; and
when the transactional limit parameter is exceeded, suspend execution of further data transactions of a first type requested by the user between the first time and the second later time.

2. The computer system in claim 1, wherein the processing system is configured, when the transactional limit is exceeded, to permit further data transactions of a second different type requested by the user between the first time and a second later time.

3. The computer system in claim 1, wherein different ones of the data transaction request messages include different units of measure, and wherein the processing system is configured to convert the different data transaction requests to a same unit of measure.

4. The computer system in claim 1, wherein the processing system is configured to permit further data transactions requested by the user between the first time and a second later time when the transactional limit parameter is not exceeded based on the monitored data transaction request messages.

5. The computer system in claim 1, wherein different ones of the data transaction requests include different units of measure, and
wherein the processing system is configured to:
calculate a difference parameter for each set of data transaction requests having a different unit of measure,
calculate the current transactional limit at a time between the first and second times using the calculated difference parameters.

6. The computer system in claim 1, wherein the processing system is configured to adjust the first limit parameter and the second limit parameter using a predetermined factor.

7. A method for processing electronic data transaction messages, comprising:
a backend computer server determining a first limit parameter associated with a user and a second limit parameter associated with the user;
a frontend server receiving from user devices electronic data transaction request messages and from the backend computer server the first limit parameter associated with the user and the second limit parameter associated with the user;
storing in a non-transitory storage medium electronic data transaction request message information associated with the user, the first limit parameter associated with the user, and the second limit parameter associated with the user;
calculating at a first time data transaction requests associated with the user and a transactional rate parameter associated with the user based on a relationship between the data transaction requests associated with the user and the second limit amount parameter;
monitoring data transaction request messages received from one or more client computers associated with the user between the first time and a second later time;
adjusting the transactional rate parameter based on data transaction requests associated with the user received between the first and second times;
calculating a transactional limit parameter using the data transaction requests associated with the user, the transactional rate parameter, and the first limit parameter;
determining whether the transactional limit parameter is exceeded; and
when the transactional limit parameter is exceeded, suspending execution of further data transactions of a first type requested by the user between the first time and the second later time.

8. The method in claim 7, further comprising, when the transactional limit is exceeded, permitting further data transactions of a second different type requested by the user between the first time and a second later time.

9. The method in claim 7, wherein different ones of the data transaction requests include different units of measure, and wherein the method further comprises converting the different data transaction requests to a same unit of measure.

10. The method in claim 7, further comprising permitting further data transactions requested by the user between the first time and a second later time when the transactional limit parameter is not exceeded based on the monitored data transaction request messages.

11. The method in claim 7, wherein different ones of the data transaction requests include different units of measure, the method further comprising:
calculating a difference parameter for each set of data transaction requests having a different unit of measure,
calculating the current transactional limit at a time between the first and second times using the calculated difference parameters.

12. The method in claim 7, further comprising adjusting the first limit parameter and the second limit parameter using a predetermined factor.
